(19) United States
(12) Patent Application Publication
(10) Pub. No.: US 2012/0249585 A1
(43) Pub. Date: Oct. 4, 2012

(54) INFORMATION PROCESSING DEVICE, METHOD THEREOF, AND DISPLAY DEVICE

(75) Inventor: Tomoki Ohkawa, Saitama-shi (JP)

(73) Assignees: Pioneer Solutions Corporation, Kawasaki-shi (JP); Pioneer Corporation, Kawasaki-shi (JP)

(21) Appl. No.: 13/508,602

(22) PCT Filed: Nov. 9, 2009
(86) PCT No.: PCT/JP2009/069066

§ 371 Date: Jun. 12, 2012

(51) Int. Cl. G06F 3/041; G09G 5/00

(52) U.S. Cl. 345/629; 345/173

(57) ABSTRACT

When an indicating situation recognizer recognizes an indicating situation on a display surface of a display unit indicated by a finger, a drawing processor superimposes a drawn image corresponding to the indicating situation onto a map displayed on the display surface. When recognizing an image masking request signal indicating that the map is hidden, an image masking processor provides a display state where the map is hidden and only the drawn image is displayed. When recognizing the indicating situation by the indicating situation recognizer while the map is masked, an image exposure processor performs an image exposure process to display the hidden map in an area corresponding to the indicating situation. Accordingly, it can be prevented that the meaning of the drawn image becomes difficult to grasp because an area irrelevant to the drawn image is displayed on the displayed map M. The meaning and the tendency of the drawn image is easily checkable on the displayed map.

### TECHNICAL FIELD

The present invention relates to an information processing device that processes according to an indicated position defined by indicating a predetermined position on a display surface of a display unit with an indicating unit, a method thereof and a display device.

### BACKGROUND ART

There has been typically known a display device configured such that a drawing, a prepared icon and the like are superimposed on an image displayed on a display surface of the display device according to an indicating locus and a movement locus obtained by dedicated stationery indicating and being moved on the display surface see, for instance, Patent Literature 1).

In Patent Literature 1, a drawing obtained by drawing on a digital pad with a stylus is superimposed on a display screen. In addition, an extracted area extracted from the image as an enclosed portion in the drawing is outputted as a partial image, the extracted area is emphasized by a color, or the inside of the enclosure is emphasized.

### CITATION LIST

### Patent Literature(s)

Patent Literature 1 JP-A-2001-195598

### SUMMARY OF THE INVENTION

### Problems to be Solved by the Invention

However, in the aforementioned typical display device disclosed in Patent Literature 1, attention may be given to the partial image obtainable by extracting a desired area from the image as the enclosed portion in the drawing, or to an image displayed around the enclosure when the inside of the enclosure is emphasized. Particularly in child education, it is noticeable that the image distracts children.

Accordingly, a meaning and a tendency of the drawing, which are expressed by a position and a size of the enclosure relative to the entirety and the number of the enclosure, may be insufficiently noticed or communicated.

An object of the invention is to provide an information processing device capable of favorably superimposing a drawing according to an indicating situation on an image, a method thereof and a display device.

Another object of the invention is to provide a display device capable of easily operating a display switching between a first display image in which an image is displayed instead of being hidden by a drawing superimposed on the image and a second display image in which the image is hidden by the drawing when superimposing a drawing according to an indicating situation on an image.

### Means for Solving the Problems

According to an aspect of the invention, an information processing device processes according to an indicated position defined by indicating a predetermined position on a display surface of a display unit with an indicating unit, and includes: an indicating situation recognizer that recognizes an indicating situation where the indicating unit indicates the display surface; a drawing processor that superimposes a drawn image according to the indicating situation recognized by the indicating situation recognizer on an image displayed on the display unit; an image masking processor that displays only the drawn image while hiding the image when recognizing an image-masking request signal requesting a state where the image on which the drawn image is superimposed is not displayed; and an image exposure processor that displays the hidden image in an area corresponding to the indicating situation when recognizing the indicating situation by the indicating situation recognizer when the image is hidden.

According to another aspect of the invention, a display device includes: a display unit having a display surface; and an information processing device according to the above aspect of the invention that processes according to an indicated position defined by indicating a predetermined position on the display surface of the display unit with an indicating unit.

According to a still another aspect of the invention, an information processing method by a computer is for processing according to an indicated position defined by indicating a predetermined position on a display surface of a display unit with an indicating unit, and includes: using a touch panel that judges the indicating unit to be in contact with the display surface when the indicating unit contacts with the display surface or when the indicating unit comes within a predetermined distance from the display surface, and outputs an area signal according to a contact area, in which the computer is configured to perform: an indicating situation recognition to recognize an indicating situation where the indicating unit indicates the display surface based on the area signal from the touch panel; an drawing process to superimpose the same drawn image as an indicating locus recognized by the indicating situation recognizer on an image displayed on the display unit; an image masking process to recognize an image-masking request signal requesting a state where the image on which the drawn image is superimposed is not displayed based on the area signal from the touch panel, and to hide an area of the image corresponding to the drawn image; and an image exposure process to recognize based on the area signal from the touch panel an image display request signal requesting a state where the hidden area is displayed when the area of the image corresponding to the drawn image is hidden, and to display the hidden area, in which each time one drawn image is indicated or one group of drawn images are indicated, the image masking process and the image exposure process are alternately performed on an area corresponding to the indicated one drawn image or one group of drawn images.

According to a further aspect of the invention, an information processing method by a computer is for processing according to an indicated position defined by indicating a predetermined position on a display surface of a display unit with an indicating unit, and includes: using a touch panel that judges the indicating unit to be in contact with the display surface when the indicating unit contacts with the display surface or when the indicating unit comes within a predetermined distance from the display surface, and outputs an area signal according to a contact area, in which the computer is configured to perform: an indicating situation recognition to recognize an indicating situation where the indicating unit indicates the display surface based on the area signal from the touch panel; an drawing process to superimpose the same drawn image as an indicating locus recognized by the indicating situation recognizer on an image displayed on the display unit; an image masking process to recognize an image-masking request signal requesting a state where the image on which the drawn image is not superimposed is not displayed based on the area signal from the touch panel, and to hide an area other than an area of the image corresponding to the drawn image; and an image exposure process to recognize based on the area signal from the touch panel an image display request signal requesting a state where the hidden area is displayed when the area other than the area of the image corresponding to the drawn image is hidden, and to display the hidden area, in which each time one drawn image is indicated or one group of drawn images are indicated, the image masking process and the image exposure process are alternately performed on an area corresponding to the indicated one drawn image or one group of drawn images.

According to a further aspect of the invention, an information processing method by a computer is for processing according to an indicated position defined by indicating a predetermined position on a display surface of a display unit with an indicating unit, in which the computer is configured to perform: an indicating situation recognition to recognize an indicating situation where the indicating unit indicates the display surface; a drawing process to superimpose a drawn image according to the indicating situation recognized by the indicating situation recognition on an image displayed on the display unit; an image masking process to recognize an image-masking request signal requesting a state where the image on which the drawn image is superimposed by the drawing process is not displayed, and to display only the drawn image while hiding the image; and an image exposure process to recognize an indicating situation by the indicating unit when the image is hidden by the image masking process, and to display the hidden image in an area corresponding to the indicating situation.

### BRIEF DESCRIPTION OF DRAWINGS

FIG. 1 is a block diagram showing a schematic structure of an electronic blackboard device according to an exemplary embodiment of the invention.

FIG. 2 schematically shows a state where a map is displayed in the electronic blackboard device in this exemplary embodiment.

FIG. 3 schematically shows a drawn image superimposed on the map in the electronic blackboard device of this exemplary embodiment.

FIG. 4 schematically shows layers displayed by the electronic blackboard device of this exemplary embodiment.

FIG. 5 schematically shows a masking image superimposed on the map in the electronic blackboard device of this exemplary embodiment.

FIG. 6 schematically shows a state where the map is partially exposed according to indication in the electronic blackboard device of this exemplary embodiment.

FIG. 7 is a flow chart showing a display processing operation in the electronic blackboard device of this exemplary embodiment.

FIG. 8 schematically shows layers displayed by an electronic blackboard device according to another exemplary embodiment of the invention.

FIG. 9 schematically shows a state where a calculation-result display window by calculation is displayed in an electronic blackboard device according to still another exemplary embodiment of the invention.

FIG. 10 schematically shows a drawn image superimposed on a map in an electronic blackboard device according to a further exemplary embodiment (modification embodiment 1) of the invention.

FIG. 11 schematically shows layers displayed by the electronic blackboard device in the modification embodiment 1.

FIG. 12 schematically layers displayed by an electronic blackboard device according to a still further exemplary embodiment of the invention.

### DESCRIPTION OF EXEMPLARY EMBODIMENT(S)

A structure of an electronic blackboard device (a display device) according an exemplary embodiment of the invention will be described below with reference to the attached drawings.

Although the electronic blackboard device is described as an example for the display device in this exemplary embodiment, the display device of the invention may be used as a display device for a portable personal computer, a desk-top personal computer, a portable terminal device such as a mobile phone and PDA (Personal Digital Assistant), a display device for business information and train information, and an operation device for an electronic device and a navigation device. In the exemplary embodiment, scrolling an image means a process of moving an image displayed on a display surface, thereby displaying a part of the image having not been displayed on the display surface before the image is moved.

### Structure of Electronic Blackboard Device 1

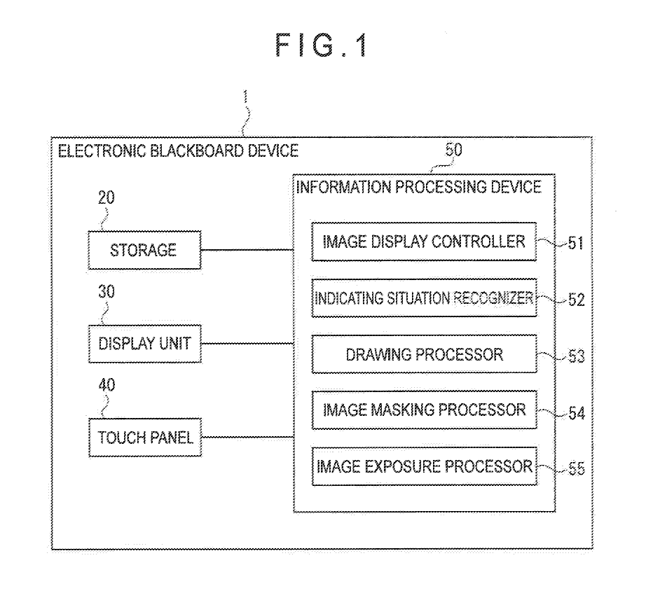

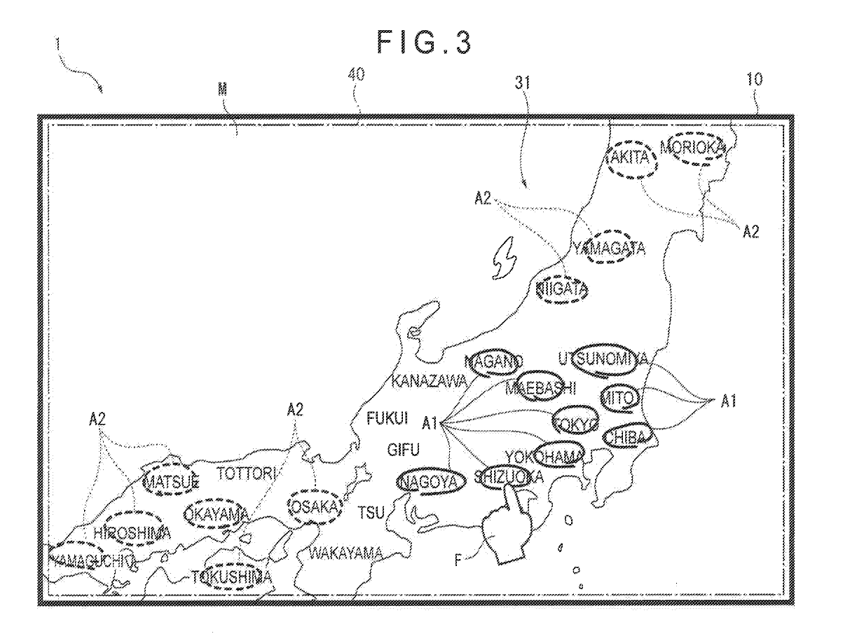

In FIG. 1, an electronic blackboard device 1 as a display device is used at school, at an office meeting and the like. Specifically, the electronic blackboard device 1 exemplarily scrolls a map M (an image) according to an indicated position on a display surface 31 with a finger F (an indicating unit) and superimposes a drawing (a drawn image) (see FIG. 3), an icon and the like on the map M.

In the exemplary embodiment, the indicating unit is exemplified by the finger F of a user to perform the process according to indicating situations by the finger F. However, examples of the indicating unit may include: various indicating units (e.g., a stylus pen and a pointer) that are configured to be capable of physical indication on the display surface 31; and a cursor that is displayed on the display surface 31 according to an input state by an input unit (e.g., a mouse or a tablet); and non-contact indicating unit (e.g., an optical pointer). In order to recognize indicating situations, any structures capable of specifying an indicated position on the display surface 31 through pressure, detection by an electrostatic sensor, voice or a visual point may be applicable.

The electronic blackboard device 1 includes a substantially box-shaped main body 10 having a surface through which the display surface 31 is exposed. The display surface 31 is provided in a vertical direction.

The main body 10 includes: a storage 20; a display unit 30 having the display surface 31; a touch panel 40; and an information processing device 50 (a computer).

The storage 20 can store various display data such as map data or video data that are displayed on the display surface 31 of the display unit 30, the display data being readable and recordable in plural forms by the information processing unit 50. The storage 20 also stores various programs running on an OS (Operating System) for controlling the whole operation of the electronic blackboard device 1.

The storage 20 may include a drive and a driver for readably storing data in various recording media including a magnetic disk such as HD (Hard Disk), an optical disk such as DVD (Digital Versatile Disc), and a memory card. Further the storage 20 may include a plurality of drives and drivers.

The display unit 30 is controlled by the information processing device 50 to display image data outputted from the information processing device 50 on a screen. Examples of the display data include the aforementioned display data stored in the storage 20, TV image data received by a TV receiver (not shown), and image data that are stored in a recording medium such as an optical disk or a magnetic disk and are read by a drive and a driver (i.e. an external device).

Various display devices for screen display are applicable to the display unit 30. Examples of the display unit 30 include a liquid crystal panel, an organic EL (Electro-Luminescence) panel, a PDP (Plasma Display Panel), a CRT (Cathode-Ray Tube), an FED (Field Emission Display) and an electrophoretic display panel. Although an input unit dedicated for the touch panel 40 is required, the display unit may be a projection-type display unit such as a projector.

The touch panel 40 covers the display surface 31 of the display unit 30 and is configured to be touchable by a user. The touch panel 40 is formed in a shape substantially identical with the display surface 31. The touch panel 40 is connected to the information processing unit 50 and outputs a contact signal regarding a contact point by the finger F to the information processing device 50. It should be noted that a component attachable to and detachable from the display surface 31 or a white board may be used instead of the touch panel. When the display surface 31 is indicated by an indicating unit such as a dedicated indicating unit or a finger, the component outputs a contact signal by detecting that the indicating unit contacts with a position of the component corresponding to the indicated position on the display surface 31, or judging the indicating unit to be in contact with the display surface 31 when the indicating unit reaches within a predetermined distance from the position of the component corresponding to the indicated position on the display surface 31. Herein, the state where the indicating unit indicates the display surface encompasses a state where the indicating unit reaches within a predetermined distance from the display surface.

For instance, the information processing device 50 includes CPU (Central Processing Unit) and various input/output ports (not shown). The input/output ports include: a storage port connected to the storage 20; a display port connected to the display unit 30; an input port connected to the touch panel and other various input units; and a communication port connected to an interface and the like connected to a communication network such as a TV receiver and the Internet.

The information processing device 50 includes: an image display controller 51; an indicating situation recognizer 52; a drawing processor 53; an image masking processor 54; and an image exposure processor 55. The above-listed components may be configured as programs.

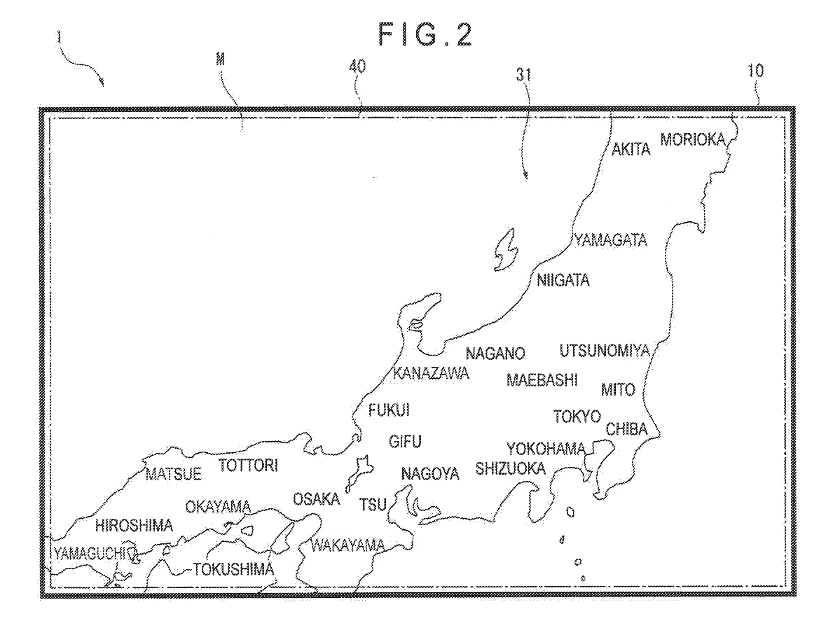

The image display controller 51 acquires image data from the storage 20 or the TV receiver according to an input operation on the touch panel 40 or by an input unit (not shown); processes the data as needed so as to be capable of being displayed on the display unit 30; and displays the data on the display unit 30 (the screen). For instance, as shown in FIG. 2, the image display controller 51 reads out map data (the display data) and displays the map M on the screen.

Moreover, the image display controller 51 displays various texts and images based on the image data on the screen.

The indicating situation recognizer 52 recognizes an indicating situation where the finger F indicates the display surface 31 of the display unit 30. The indicating situation may be various operation situations, examples of which include: a contact operation in which the display surface 31 is touched or pressed with the finger F; a so-called tap of a short contact operation within a predetermined time; drag that is a moving operation on the display surface 31 while being kept in contact with the display surface 31; and a double-tap that is an operation in which tapping is repeated plural times (e.g., twice) within a predetermined period of time.

Specifically, the indicating situation recognizer 52 acquires a position on the display surface 31 where the contact operation or the tap operation is performed, as positional information represented by, for instance, coordinates. The indicating situation recognizer 52 may be configured to recognize a pressing strength as well as the positional information. Moreover, the indicating situation recognizer 52 acquires a moving situation of the drag operation, i.e., a movement locus where the finger F has moved on the display surface 31. The movement locus may include any data such as vector information and dot information.

The indicating situation recognizer 52 outputs indicating situation information such as the positional information according to the indicating situation to the drawing processor 53 and the image exposure processor 55.

As shown in FIG. 3, the drawing processor 53 superimposes drawn images A1 and A2 according to the indicating situation recognized by the indicating situation recognizer 52 onto the image (e.g., the map M) displayed on the display unit 30.

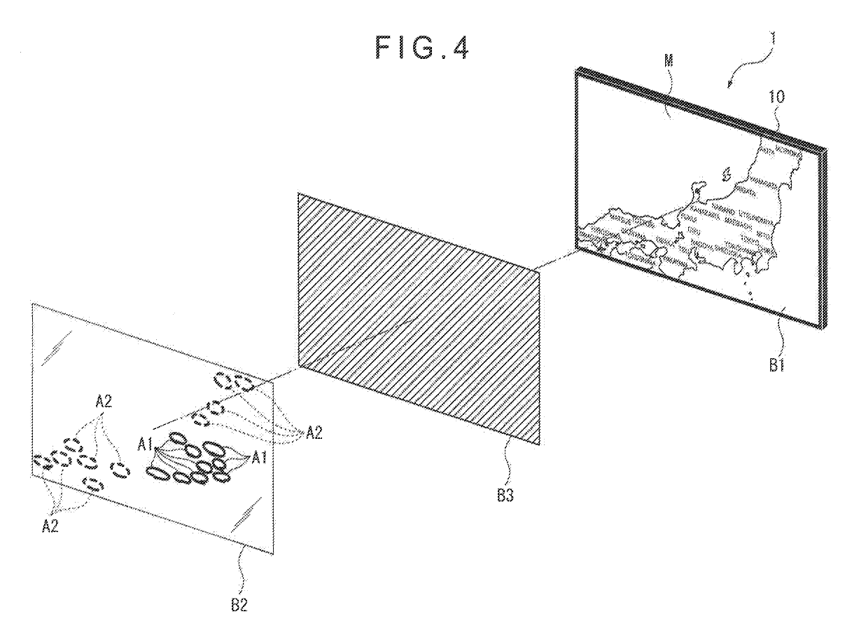

Specifically, as shown in FIG. 4, the drawing processor 53 superimposes a transparent drawing area B2 (a transparent image) onto a display area B1 of the image displayed on the display surface 31, the transparent drawing area B2 having the same size as that of the display area B1. The drawing processor 53 acquires the indicating situation information outputted from the indicating situation recognizer 52 and displays the drawn images A1 and A2 according to the indicating situations on the display unit 30. The transparent drawing area B2 is layered on the display area B1 to provide a layered structure. When the drawn images A1 and A2 are displayed on the transparent drawing area B2, the drawn images A1 and A2 are visually recognized as being superimposed on the map M.

Under this state, for instance, when a drag operation is performed to scroll the map M so as to change a displayed area of the map M displayed on the display surface 31 to another displayed area, an image process to move the drawn images A1 and A2 accordingly may be performed. When a scale of the map M is changed by a predetermined input operation, a scale of each of the drawn images A1 and A2 may be changed accordingly.

For instance, when the drawing processor 53 recognizes indicating situation information indicating that a double-tap has been made on a predetermined area on the display surface 31, the drawing processor 53 displays a tool box such as an input pad for setting a display form (e.g., a line type, a color, and a thickness) of the drawn images A1 and A2 and an input pad for displaying a plurality of icons (e.g., an arrow, a symbol, a character, an animal, and a portrait) in a selectable manner.

After superimposing the drawn images A1 and A2 on the map M (the image), the drawing processor 53 outputs to the image masking processor 54 a signal indicating that the drawing process of this superimposition has been performed.

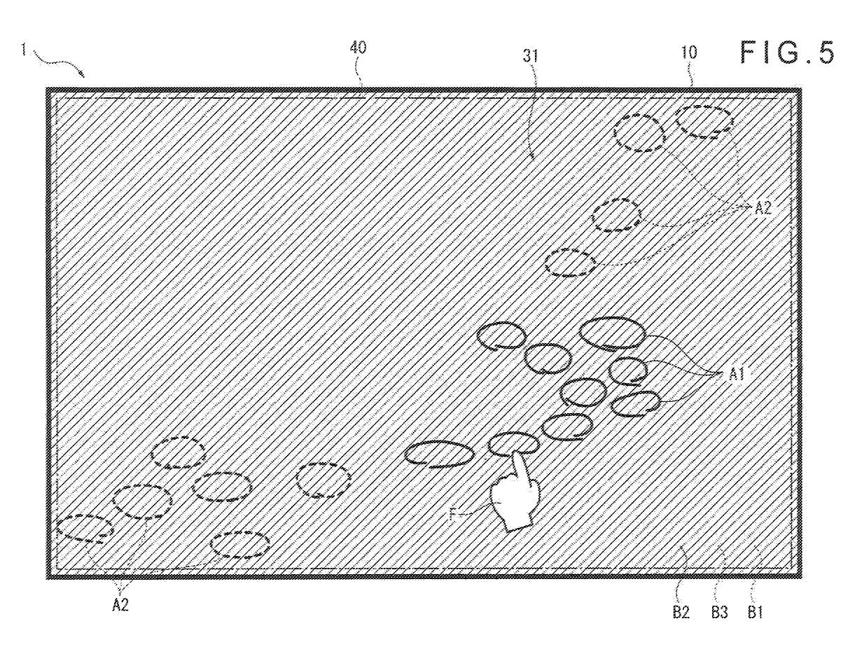

As shown in FIG. 5, the image masking processor 54 processes to provide a display state where the drawn images A1 and A2 are being displayed while only the image (the map M), on which the drawn images A1 and A2 are superimposed, is not displayed.

In other words, after receiving the signal indicating that the drawing processor 53 has performed the drawing process, while the image on which the drawn images A1 and A2 are superimposed is being displayed, the image masking processor 54 is brought into a waiting state for receiving an image-masking request signal that requests a display state where the image is not displayed. The image-masking request signal may be, for instance, an input operation by an input unit (not shown) and a double-tap in a predetermined area on the display surface 31.

After recognizing the image-masking request signal, the image masking processor 54 performs an image masking process to hide the map M and display only the drawn images A1 and A2. As shown in FIG. 4, in the image masking process, an opaque masking drawing-area B3 (a masking image) is interposed between the transparent drawing area B2 and the display area B1 of the image displayed on the display surface 31 for superimposition, the masking drawing-area B3 having the same size as that of the display area B1. The opaque masking drawing-area B3 is, for instance, a single-colored screen (e.g., a gray screen) such as a blue screen different from the drawn images A1 and A2. The display area B1, the masking drawing-area B3, and the transparent drawing area B2 are sequentially layered to provide a layered structure. Accordingly, the map M of the display are B1 is covered with the gray screen of the masking drawing-area B3 and the drawn images A1 and A2 are visually recognized as being superimposed on the gray screen.

After performing the image masking process in which the map M is hidden and not displayed, the image masking processor 54 outputs to the image exposure processor 55 a signal indicating that the image masking process has been performed.

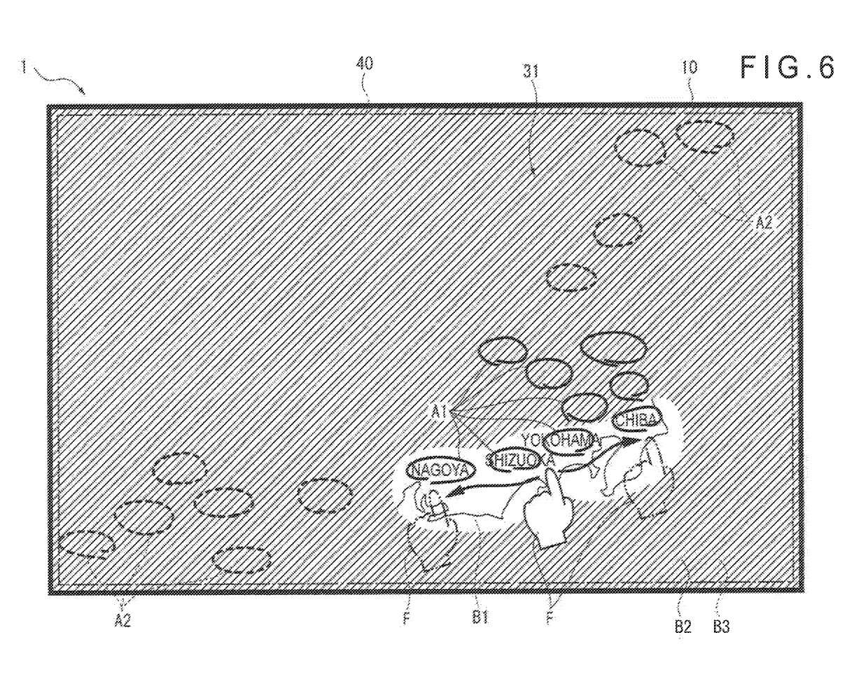

After the image exposure processor 55 recognizes the indicating situation by the indicating situation recognizer 52 while the map M is hidden in the image masking process by the image masking processor 54, as shown in FIG. 6, the image exposure processor 55 performs an image exposure process to display the map M hidden in an area corresponding to the indicating situation.

In other words, after acquiring the indicating situation information outputted from the indicating situation recognizer 52 under the state shown in FIG. 4, the image exposure processor 55 changes the single-colored display of the area corresponding to the indicating situation on the masking drawing-area B3 to a transparent display. By this process, the map M can be visually recognized through the transparent area of the masking drawing-area B3. As a specific operation, for instance, a specific part of the display surface 31 is traced with a finger or an indicating pen, so that an indicating locus is drawn. When an image exposure process for the indicating locus is performed, a specific area of the map M can be displayed as shown in FIG. 6. In this process, an area for image exposure can be easily specified by setting a line width of the indicating locus to be bold. Alternatively, an indicating movement to enclose the specific area of the display surface 31 with a finger or an indicating pen may be performed to draw a closed graphic by an indicating locus. Then, an image exposure process may be performed on the area enclosed by the indicating locus. In this process, the image exposure process can be performed on a broader area without setting a line width of the indicating locus to be bold. When the indicating locus is partially discontinued not to form a closed graphic in the indicating movement to enclose the specific area, similarly to an enclosed-drawing-area extracting method described in Patent Literature 1, an outline possibly representing the drawn enclosed area is formed, and a characteristic point of the outline is calculated, whereby the enclosed area can be reformed based on the characteristic point. Alternatively, such an outlined graphic obtained by reforming the drawing of the user can be processed as an indicating locus by a method of drawing a quadrangle with a diagonal between a start point and a finish point of the drawn line and a method of drawing a circle, an ellipse, a combined graphic of a circle and a quadrangle and the like that are inscribed or circumscribed on the above quadrangle with the diagonal. It is recognized to which of the prepared quadrangle, ellipse, circle and combined graphic of the circle and the quadrangle a shape of the indicating locus drawn by the user corresponds, thereby reforming the recognized graphic. This method can be used even in another exemplary embodiment described later.

The image exposure processor 55 may perform a process to collectively remove the masking of the map M by a predetermined input operation such as a double tap at a predetermined position on the display surface 31 as the indicating situation information. In such a collective exposure process, for instance, the masking drawing-area B3 may be removed to provide a double structure of the display area B1 and the transparent drawing area B2, or the entire masking drawing-area B3 may be changed to a transparent display. The transparent masking drawing-area B3 may be returned to be opaque and the masking process of the map M may be performed by the image masking processor 54.

### Display Process of Electronic Blackboard Device 1

Next, a display processing operation of the electronic blackboard device 1 will be described with reference to the drawings.

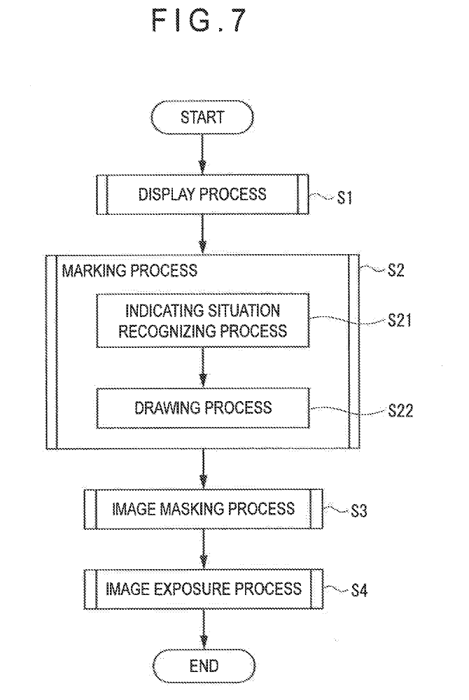

FIG. 7 is a flow chart showing a display processing operation as an information process in the electronic blackboard device.

First of all, the user supplies electrical power to the electronic blackboard device 1 for driving.

After driving the electronic blackboard device 1, in response to a predetermined input operation by the user, the information processing device 50 of the electronic blackboard device 1 performs a display process to display image data on the display unit 30 as shown in FIG. 7 (Step S1).

Specifically, by the input operation such as a tapping on a predetermined area of the display surface 31 by an input device or a finger F (not shown), the image display controller 51 of the information processing device 50 acquires the image data stored in the storage 20 of the electronic blackboard device 1, image data provided on the internet, and the like. Subsequently, the image display controller 51 processes the acquired image data (e.g., the map data) to output the processed data to the display unit 30 for display on the screen as shown in FIG. 2.

After the display process of the image data, the information processing device 50 performs a marking process (Step S2).

Specifically, the indicating situation recognizer 52 of the information processing device 50 judges whether the image data after the display process is indicated on the map M (the displayed image). In other words, the indicating situation recognizer 52 is brought into a waiting state for inputting an indicating situation such as contact with the finger F of the user on the display surface 31.

Subsequently, when the indicating situation recognizer 52 recognizes the indicating situations, the indicating situation recognizer 52 performs an indicating situation recognition (Step S21).

Specifically, on recognizing the indicating situations, the indicating situation recognizer 52 recognizes the position in contact with the display surface 31 (the indicating situations) and the movement locus (the drag operation) to produce indicating situation information such as the positional information and the vector information. Subsequently, the indicating situation recognizer 52 outputs the produced indicating situation information to the drawing processor 53.

When receiving the outputted indicating situations, the drawing processor 53 performs a drawing process (Step S22).

Specifically, the drawing processor 53 displays the drawn images A1 and A2 on the transparent drawing area B2 according to the indicating situations of the received indicating situation information, in which the transparent drawing area B2 is superimposed on the display area B1 displaying the map M. When the drawn images A1 and A2 are displayed, the drawn images A1 and A2 are superimposed on the map M as shown in FIG. 3 for display.

After superimposing the drawn images A1 and A2 on the map M, the drawing processor 53 outputs a signal indicating that the drawing process has been performed, and is brought into a waiting state for receiving another indicating situation information. When the drawing processor 53 further acquires indicating situation information under the reception waiting state, the drawing processor 53 repeats the drawing process according to the indicating situations.

After performing the marking process in Step S2, the information processing device 50 performs an image masking process according to an input operation by the user in reply to the request to hide the map M (Step S3).

Specifically, when receiving the signal from the drawing processor 53 indicating that the drawing processor 53 finished the drawing process, the image masking processor 54 of the information processing device 50 is brought into a waiting state for receiving an image-masking request signal that requests a display state where the map M is hidden and not displayed. When receiving the image-masking request signal according to the predetermined input operation by the user, the image masking processor 54 performs an image process to change the masking drawing-area B3 from in a transparent state to in a color different from the drawn images A1 and A2 (e.g., in a gray color that is opaque). With this image process, as shown in FIG. 5, the drawn images A1 and A2 are superimposed on the gray screen and the map M is displayed in a state where the map M is hidden by the gray screen and cannot be visually checked.

After performing the image process to provide the display state where the map M is hidden and not displayed as shown in FIG. 5, the image masking processor 54 outputs to the image exposure processor 55 a signal indicating that the image masking process has been performed.

After performing the image masking process in Step S3, the information processing device 50 performs an image exposure process according to an input operation in response to a request by the user to expose the map M (Step S4).

Specifically, when receiving the signal from the image masking processor 54 indicating that the image masking processor 54 finished the image masking process, the image exposure processor 55 of the information processing device 50 is brought into a waiting state for receiving indicating situation information from the indicating situation recognizer 52 in response to a request by the user to display the hidden map M. Subsequently, when acquiring the indicating situation information, as shown in FIG. 6, the image exposure processor 55 changes the single-colored display of the area corresponding to the indicating situation in the masking drawing-area B3 (e.g., the area of the movement locus by the finger F) to a transparent display thereof. With this process, the map M can be visually checked through the transparent area of the masking drawing-area B3. Alternatively, a closed graphic may be drawn by the movement locus of the finger F and a single-colored display of an area within the closed graphic may be changed to a transparent display. According to these methods, the map M can be visually checked through the transparent area of the masking drawing-area B3.

The masking of the map M may be collectively removed for display by a predetermined input operation. Moreover, while the entire map M being exposed by a predetermined input operation, the image masking process of Step S3 may be repeated.

Although a switching between the transparent display and the opaque display of the area specified by the movement locus of the finger F on the masking drawing-area B3 or a switching between the transparent display and the opaque display of the entire masking drawing-area B3 is performed by the image masking processor 54 and the image exposure processor 55, such a switching may be performed by touching with the finger F an icon button for controlling the masking drawing-area B3 displayed on the display surface 31. With this structure, each time the user operates on the icon, in other words, the same operation is repeated by the input unit, the specific area defined by the movement locus of the finger F as described above can be switched between the single-colored display and the transparent display. Alternatively, each time the user operates on the icon, the entire masking drawing-area B3 can be switched between the single-colored display and the transparent display.

### Advantages of Electronic Blackboard Device 1

As described above, in the above exemplary embodiment, when the indicating situation recognizer 52 recognizes the indicating situation on the display surface 31 of the display unit 30 indicated by the finger F, the drawing processor 53 superimposes the drawn images A1 and A2 according to the indicating situation onto the map M displayed on the display surface 31. Under such a state, when receiving the image-masking request signal that is inputted by the input operation by the user and indicating that the map M is to be hidden and not displayed, the image masking processor 54 provides a display state where the map M is hidden and only the drawn images A1 and A2 are displayed. When recognizing the indicating situation based on the indicating situation information outputted from the indicating situation recognizer 52 under the image masking process, the image exposure processor 55 performs the image exposure process to display the map M hidden in the area corresponding to the area corresponding to the indicating situation.

With this structure, the map M is hidden after the drawn images A1 and A2 are displayed and is again displayed according to the indicating situation. Accordingly, it can be prevented that the meaning of the drawn images A1 and A2 becomes difficult to grasp, for instance, because an area irrelevant to the drawn images A1 and A2 is displayed on the displayed map M. In addition, the drawn images A1 and A2 can be easily checked in relation to the displayed map M in terms of the meaning, the tendency and the like. Accordingly, a favorable superimposition of the drawn images A1 and A2 on the map M can be provided so that the drawn images A1 and A2 are suitably recognized.

in this exemplary embodiment, in the image masking process by the image masking processor 54, the masking drawing-area B3 (the masking image) that is entirely single-colored (gray) differently from the color of the drawn images A1 and A2 is superimposed on the display area B1 displaying the map M, thereby hiding the map M and only displaying the drawn images.

With a simple layered structure and a simple process to display the masking drawing-area B3 (a target layer) in a single color, it can be easily prevented that the meaning of the drawn images A1 and A2 becomes difficult to grasp due to the display of the map M.

Moreover, the masking drawing-area B3 to hide the map M is interposed between the transparent drawing area B2 displaying the drawn images A1 and A2 and the display area B1 displaying the map M and is superimposed on the map M.

Accordingly, with a simple layered structure, such an image process in which the drawn images A1 and A2 are displayed while the map M is hidden and not displayed can be easily performed.

In this exemplary embodiment, in the image exposure process by the image exposure processor 55, the hidden map M is revealed by changing the color of the masking drawing-area B3 to a transparent state where the superimposed map M is visible through the masking drawing-area B3.

Accordingly, with a simple image process of the masking drawing-area B3 to perform the same process as that of the drawn images A1 and A2 with a simple layered structure, the map M can be redisplayed and checked, so that the user can easily grasp the meaning of the drawn images A1 and A2.

it might be considered as one of ideas for not displaying the map M that the display area B1 is displayed in gray without displaying the map M in the display area B1.

However, with such a structure, for redisplaying a part of the map M, the part of the map M needs to be read out to perform an image process for display, which takes time before the map M is displayed.

On the other hand, with the layered structure for masking the map M in this exemplary embodiment, not only the map M is hidden but also the image exposure process to expose a part of the hidden map M is rapidly processed to provide a smooth display.

The electronic blackboard device 1 of the exemplary embodiment includes the information processing device that masks and exposes the map M.

Accordingly, driving of the electronic blackboard device 1 can easily provide the drawn images A1 and A2 favorably superimposed on the map M for a suitable recognition of the drawn images A1 and A2.

Moreover, with switching arrangement between a first display image in which the map M is masked and a second display image in which the map M is exposed each time the user operates on the icon, an operation can be facilitated.

### MODIFICATION(S)

Though the present invention has been described above with reference to the embodiment, the scope of the invention is not limited thereto but includes various improvements and variations in the design as long as an object of the present invention can be achieved.

As described above, the invention is applicable not only to the electronic blackboard device 1 but also to a personal computer, a portable terminal device such as a mobile phone and PDA (Personal Digital Assistant), a display device for business information and in-vehicle information, and an operation device for an electronic device and a navigation device.

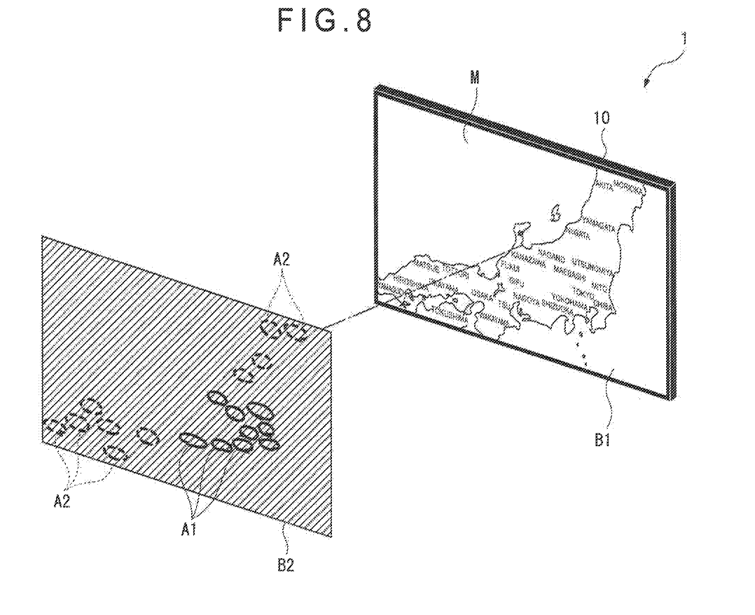

In the above exemplary embodiment, the layered structure in which the display area B1, the masking drawing-area B3 and the transparent drawing area B2 are sequentially layered is exemplarily shown. However, for instance, a double-layered structure may be used as shown in FIG. 8. Specifically, the double-layered structure is a layered structure in which the transparent drawing area B2 is layered on the display area B1. The drawn images A1 and A2 are drawn on the transparent drawing area B2. When hiding the image, transparent parts other than the drawn images A1 and A2 on the transparent drawing area B2 are displayed opaque in a single color (e.g., gray) different from the color of the drawn images A1 and A2 (i.e., in the same manner as on the masking drawing-area B3), thereby displaying the drawn images A1 and A2 while hiding the image. Thus, the transparent drawing area B2 serves as a layer where the drawn images A1 and A2 are drawn as well as a layer functioning as the masking image of the invention in the same manner as the masking drawing-area B3 of the above exemplary embodiment.

As the layered structure, for instance, the display area B1, the transparent drawing area B2 and the masking drawing-area B3 may be sequentially layered. In this structure, a part of the masking drawing-area 93 corresponding to the drawn images A1 and A2 of the transparent drawing area 92 may be made transparent to display the drawn images A1 and A2 through the masking drawing-area B3 for visual check, which provides the same display as the above. Thus, the invention is applicable to any image process of hiding the image and displaying the hidden parts of the image depending on the indicating situation.

In the above exemplary embodiment, the structure configured to provide different display forms in the same manner as the drawn images A1 and A2 is exemplarily described. However, the structure may be configured to provide a display form simply in a single color.

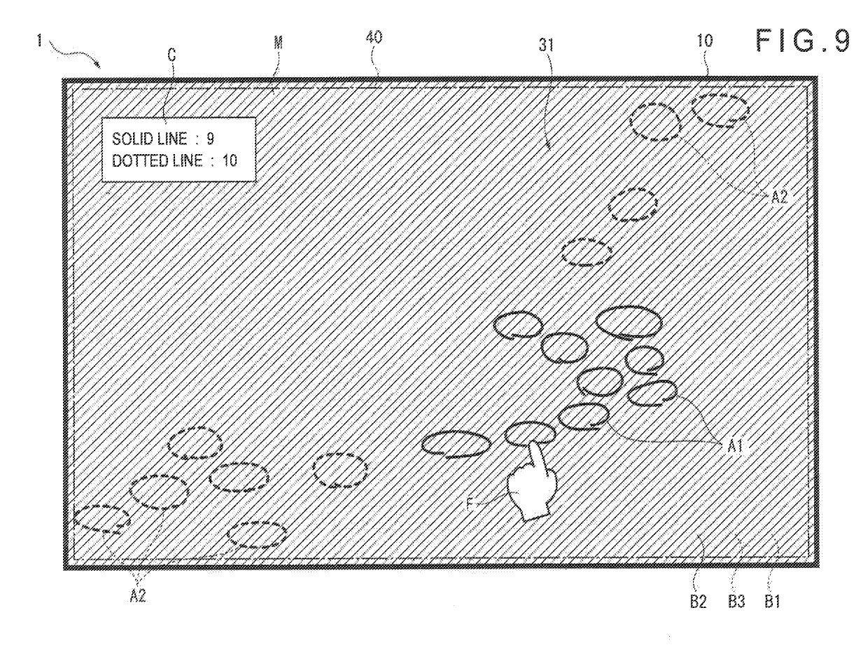

When the drawn images A1 and A2 can be displayed in different forms, for instance, as shown in FIG. 9, each form of the drawn images A1 and A2 may be counted and the count results may be shown in a window as a count-result-display window C.

In addition to the counting of the drawn images A1 and A2 in different display forms as shown in FIG. 9, for instance, a timer may be provided, whereby time information on the drawn image data such as a drawing time, a setting time, and a drawing period of time elapsed from start to end are related to each other and calculated according to time zones.

Although the tool box is displayed according to the indicating situation to display various drawn images, the contents of the tool box is not limited to the above.

A structure without a tool box may be applicable.

Further, as described below, an image on the area where the drawn images A1 and A2 are superimposed may be masked (hereinafter referred to as a modification embodiment 1).

Specifically, as shown in FIG. 3, the drawing processor 53 superimposes the drawn images A1 and A2 corresponding to the indicating situation recognized by the indicating situation recognizer 52 onto the image displayed on the display unit 30, e.g., the map M. The drawn images A1 and A2 each are an enclosed area drawn by a closed graphic of the indicating locus by enclosing the specific part of the display surface 31, for instance, with a finger. A detailed description of a method for superimposing the drawn images A1 and A2 on the map M by the drawing processor 53 is omitted since the same structure shown in FIG. 4 as that of the above exemplary embodiment is used in the process.

In this structure, when the map M is scrolled by a predetermined operation, an image process to move the drawn images A1 and A2 in accordance with the map M may be performed. When the scale of the map M is changed, an image process to change the scale of the drawn images A1 and A2 accordingly may be performed.

For instance, when the drawing processor 53 recognizes indicating situation information, the drawing processor 53 displays a tool box such as an input pad for setting a display form (e.g., a line type, a color, and a thickness) of the drawn images A1 and A2 and an input pad for displaying a plurality of icons (e.g., an arrow, a symbol, a character, an animal, and a portrait) in a selectable manner.

After superimposing the drawn images A1 and A2 on the map M (the image), the drawing processor 53 outputs to the image masking processor 54 a signal indicating that the drawing process of this superimposition has been performed.

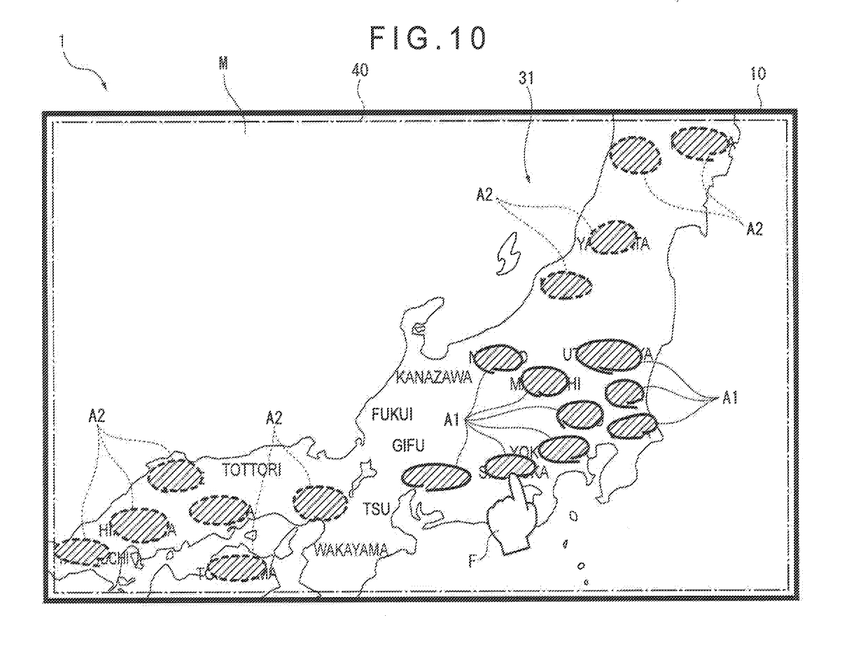

As shown in FIG. 10, in the image on which the drawn images A1 and A2 are superimposed, the image masking processor 54 displays an area of the image where the drawn images A1 and A2 are not overlapped (i.e., a non-enclosed area in the drawn images A1 and A2) while not displaying only an area of the image where the drawn images A1 and A2 are overlapped (i.e., an enclosed area in the drawn images A1 and A2).

In other words, when receiving the signal indicating that the drawing processor 53 has performed the drawing process, while the image on which the drawn images A1 and A2 are superimposed is being displayed, the image masking processor 54 is brought into a waiting state for receiving an image-masking request signal that requests a display state where the image is not displayed. The image-masking request signal is, for instance, an input operation by an input unit (not shown) or a double tap in a predetermined area on the display surface 31.

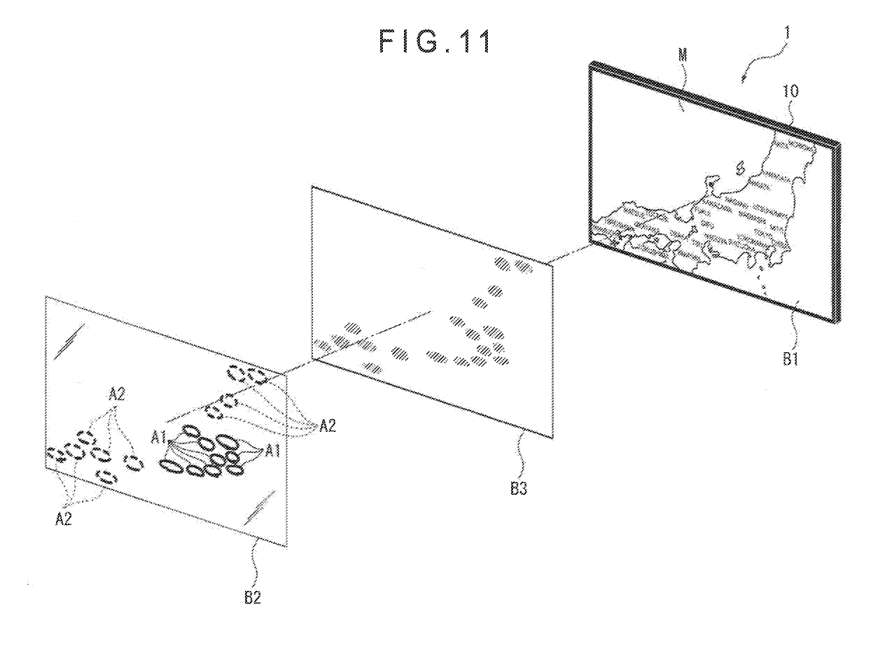

After recognizing the image-masking request signal, the image masking processor 54 performs an image masking process to hide an area of the map M where the drawn images A1 and A2 are overlapped and only display an area of the map M where the drawn images A1 and A2 are not overlapped. As shown in FIG. 11, in the image masking process, the area of the image displayed on the display surface 31, with which the drawn images A1 and A2 are overlapped, is made opaque and the area of the image with which the drawn images A1 and A2 are not overlapped is made transparent to provide the masking drawing-area B3. The masking drawing-area B3 is interposed between the transparent drawing area B2 and the display area B1 of the image to be superimposed on the image.

Although a color of the area of the masking drawing-area B3 with which the drawn images A1 and A2 are overlapped is desirably the same as the color of the drawn images A1 and A2, a different color may be used. With the layered structure in which the display area B1, the masking drawing-area B3, and the transparent drawing area B2 are sequentially layered, the map M of the display are B1 is masked with the opaque area of the masking drawing-area B3 with which the drawn images A1 and A2 are overlapped. Accordingly, the display area B1 with which the drawn images A1 and A2 are overlapped cannot be visually recognized.

After performing the image masking process in which the area of the map M with which the drawn images A1 and A2 are overlapped is hidden and not displayed, the image masking processor 54 outputs to the image exposure processor 55 a signal indicating that the image masking process has been performed.

In the modification embodiment 1, the drawn images A1 and A2 mean enclosed areas in a closed graphic of the indicating locus by enclosing a specific part of the display surface 31, for instance, with a finger. Such drawn images A1 and A2 are suitable for hiding a relatively large area. An indicating locus provided by tracing the specific part of the display surface 31 with a finger can also be defined as the drawn images A1 and A2. In this case, even when the drawn images A1 and A2 are drawn as shown in FIG. 10, only an area where the drawn images A1 and A2 are overlapped with lines of the indicating locus can be hidden. Accordingly, it is necessary to fill the entirety of a target hidden area with an indicating locus by setting a line width of the indicating locus to be bold. In this case, a continuous area provided by the indicating locus is defined as an independent drawn image.

While the image on which the drawn images A1 and A2 are superimposed is being displayed, the input operation by the input device (not shown) can also provide a waiting state for receiving a masking request or an unmasking request of the area of the masking drawing-area B3 with which plural drawn images A1 and A2 are respectively and independently overlapped. For instance, in this waiting state, when a drawn image expressed by “Shizuoka” in FIG. 3 is touched with the finger F, only the area of the masking drawing-area B3 with which the drawn image expressed by “Shizuoka” is overlapped becomes opaque as a masking image. Under this state, when the opaque area is touched with the finger F, the opaque area becomes transparent to display the drawn image expressed by “Shizuoka” Thus, while the image on which the drawn images A1 and A2 is being displayed, each time the respective drawn images are touched with the finger F, the first display image in which the image of the area overlapped with the drawn images is displayed instead of being hidden and the second display image in which the image of the area overlapped with the drawn images is hidden can be switched.

An area corresponding to the area of the masking drawing-area B3 with which the drawn image is overlapped preferably has a 0% transparency for hiding the image although not necessarily 0%. The transparency may be determined according to the color of the area corresponding to the masking drawing-area B3, or may be determined by the user. In the modification embodiment 1, the masking request and the unmasking request of the areas with which the drawn images are overlapped are independently controlled. However, the first display image in which an image on the area where all the drawn images A1 are overlapped is displayed instead of being hidden and the second display image in which the image on the area where all the drawn images A1 are overlapped is hidden may be switched, each time any one of the drawn images of the drawn images A1 enclosed by the solid line is touched with finger F. Similarly, each time any one of the drawn image A2 enclosed by a dotted line is touched with the finger F, the first display image in which images on the area where all the drawn images A2 are overlapped are displayed and the second display image in which the images on the area on which all the drawn images A2 are overlapped are hidden may be switched.

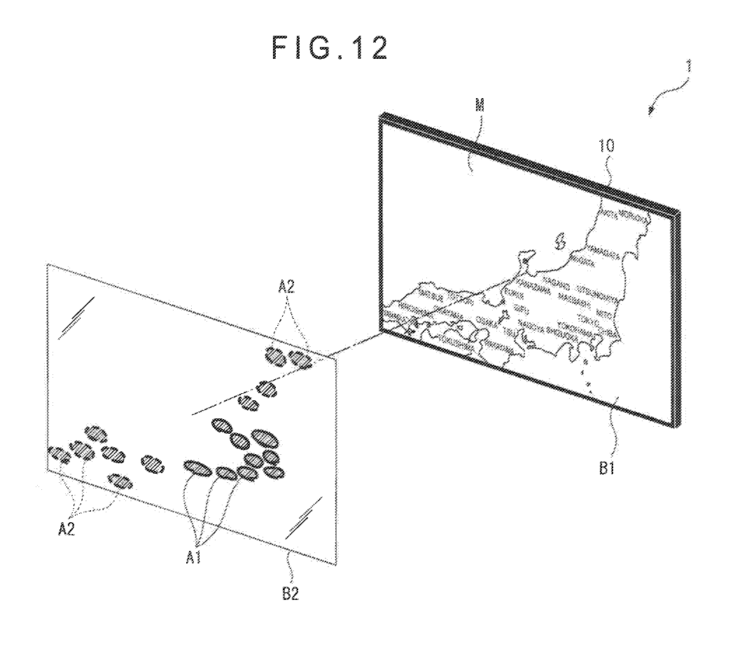

In the modification embodiment 1, the layered structure in which the display area B1, the masking drawing-area B3 and the transparent drawing area B2 are sequentially layered is exemplarily shown. However, for instance, a double-layered structure may be used as shown in FIG. 12.

When the area enclosed by the enclosed graphic drawn by the indicating locus is defined as the drawn images A1 and A2, specifically, the drawn images A1 and A2 are drawn on the transparent drawing area B2 in the layered structure in which the transparent drawing area B2 is layered on the display area B1. For hiding the images, the transparent part of the area of the transparent drawing area B2 with which the drawn images A1 and A2 are overlapped is made opaque in a single color (e.g., gray), thereby hiding the images corresponding to the drawn images A1 and A2. The transparency of the area to be made opaque is not necessarily 0%. The transparency may be determined according to the color of the area corresponding to the masking drawing-area B3, or may be determined by the user.

When the area filled with the indicating locus is defined as the drawn images A1 and A2, as long as the drawn images A1 and A2 are displayed opaque, the images of the area with which the drawn images A1 and A2 are overlapped are automatically hidden.

Even in this double-layered structure, a masking state and an unmasking state of the images with the area on which the drawn images are overlapped are independently controllable. In other words, each time the respective drawn images are touched with the finger F, the first display image in which an image of the area overlapped with the drawn image is displayed instead of being hidden and the second display image in which the image of the area overlapped with the drawn image is hidden can be switched.

The modification embodiment 1 is exemplarily configured to provide a display state in which the area with which the drawn images A1 and A2 are not overlapped is displayed while the area with which the drawn images A1 and A2 are overlapped is hidden, in the images on which the drawn images A1 and A2 are superimposed. To the contrary, a display state in which the area with which the drawn images A1 and A2 are overlapped is displayed while the area with which the drawn images A1 and A2 are not overlapped is hidden may be provided in the images on which the drawn images A1 and A2 are superimposed (hereinafter referred to as a modification embodiment 2). In short, in the image on which the drawn images A1 and A2 are superimposed, only the area overlapped with the drawn images A1 and A2 may be displayed. Under this state, modes are switchable according to an input operation by an input device (not shown). The respective images of the area with which the displayed drawn images A1 and A2 are overlapped may be switchable between a display state and a masked state. Specifically, each time the respective drawn image are touched with a finger or a pen under this state, or each time a click operation is performed by a mouse when a cursor is moved to a position of the drawn image, the first display image and the second display image are switchable. The first display image is provided by displaying only the area of the image overlapped with the drawn image that is superimposed on the image. The second display image is provided by masking only the area of the image overlapped with the drawn image indicated with a finger, a pen or a cursor among the displayed images, or by masking the area of the image overlapping with drawn images in the same group of the indicated drawn image among the displayed images.

Corresponding to a modification example 1, an information processing method by a computer is for processing according to an indicated position defined by indicating a predetermined position on a display surface of a display unit with an indicating unit, and includes: using a touch panel that judges the indicating unit to be in contact with the display surface when the indicating unit contacts with the display surface or when the indicating unit comes within a predetermined distance from the display surface, and outputs an area signal according to a contact area, in which the computer is configured to perform: an indicating situation recognition to recognize an indicating situation where the indicating unit indicates the display surface based on the area signal from the touch panel; an drawing process to superimpose the same drawn image as an indicating locus recognized by the indicating situation recognition method on an image displayed on the display unit; an image masking process to recognize an image-masking request signal requesting a state where the image on which the drawn image is superimposed is not displayed based on the area signal from the touch panel, and to hide an area of the image corresponding to the drawn image; and an image exposure process to recognize based on the area signal from the touch panel an image display request signal requesting a state where the hidden area is displayed when the area of the image corresponding to the drawn image is hidden, and to display the hidden area, in which each time one drawn image is indicated or one group of drawn images are indicated, the image masking process and the image exposure process are alternately performed on an area corresponding to the indicated one drawn image or one group of drawn images.

Thus, since the area of the image that is displayed on the display surface and corresponds to the drawn images can be hidden, it is easy to hide only an undesired area of the prepared images.

Corresponding to a modification example 2, an information processing method by a computer is for processing according to an indicated position defined by indicating a predetermined position on a display surface of a display unit with an indicating unit, and includes: using a touch panel that judges the indicating unit to be in contact with the display surface when the indicating unit contacts with the display surface or when the indicating unit comes within a predetermined distance from the display surface, and outputs an area signal according to a contact area, in which the computer is configured to perform: an indicating situation recognition to recognize an indicating situation where the indicating unit indicates the display surface based on the area signal from the touch panel; an drawing process to superimpose the same drawn image as an indicating locus recognized by the indicating situation recognition method on an image displayed on the display unit; an image masking process to recognize an image-masking request signal requesting a state where the image on which the drawn image is not superimposed is not displayed based on the area signal from the touch panel, and to hide an area other than an area of the image corresponding to the drawn image; and an image exposure process to recognize based on the area signal from the touch panel an image display request signal requesting a state where the hidden area is displayed when the area other than the area of the image corresponding to the drawn image is hidden, and to display the hidden area, in which each time one drawn image is indicated or one group of drawn images are indicated, the image masking process and the image exposure process are alternately performed on an area corresponding to the indicated one drawn image or one group of drawn images.

Thus, when the undesired area is broader among the prepared images, an area not to be hidden can be specified by a drawn image. In other words, two modes including a mode in which an area to be hidden is specified by a drawing and a mode in which an area not to be hidden specified by a drawing are provided, thereby achieving an information processing method having an improved operability.

In the information processing method according the modification embodiments 1 and 2, each time one drawn image or one group of drawn images are indicated, the image masking process and the image exposure process are alternately performed on the area corresponding to the indicated one drawn image or one group of drawn images. Accordingly, each time the corresponding drawn image is touched with a finger or a pen, the first display image or the second display image that corresponds to the drawn image indicated by the indicating unit (e.g., a finger or a pen) can be switched. Consequently, the masking process and the unmasking process can be performed only on the area corresponding to the specified drawn image or the area corresponding to the specified group of drawn images.

Examples of the same operation by the input unit in the information processing methods according to the modification embodiments 1 and 2 include execution of a click operation by a mouse each time the corresponding drawn image is touched with a finger or a pen or when a cursor is moved at a position of the corresponding drawn image. The first display image and the second display image are switched each time this operation is recognized (the image masking process and the image exposure process are switched).

In the information processing method according to the modification embodiments 1 and 2 or the above exemplary embodiment, the area of the image corresponding the drawn image is preferably an area filled with the indicating locus or an area enclosed by the indicating locus.

With this structure, a specifying method can be selected depending to a size and a shape of a desired area.

The specific structures and procedures for carrying out the invention may be modified as necessary as long as an object of the invention can be achieved.

### ADVANTAGES OF EMBODIMENTS

As described above, when the indicating situation recognizer 52 recognizes the indicating situation on the display surface 31 of the display unit 30 indicated by the finger F, the drawing processor 53 superimposes the drawn images A1 and A2 according to the indicating situation onto the map M displayed on the display surface 31. Under such a state, when receiving the image-masking request signal that is inputted by the input operation by the user and indicating that the map M is hidden and not displayed, the image masking processor 54 provides a display state where the map M is hidden and only the drawn images A1 and A2 are displayed. When recognizing the indicating situation based on the indicating situation information outputted from the indicating situation recognizer 52 under the image masking process, the image exposure processor 55 performs the image exposure process to display the map M hidden in the area corresponding to the area corresponding to the indicating situation.

With this structure, it can be prevented that the meaning of the drawn images A1 and A2 becomes difficult to grasp, for instance, because an area irrelevant to the drawn images A1 and A2 is displayed on the displayed map M. In addition, the drawn images A1 and A2 can be easily checked against the displayed map M in terms of the meaning, the tendency and the like. Accordingly, the drawn images A1 and A2 can be brought into a favorable superimposition on the map M for a suitable recognition of the drawn images A1 and A2.

### EXPLANATION OF CODES

1 electronic blackboard device
30 display unit
31 display surface
40 touch panel
50 information processing device serving as computer
52 indicating situation recognizer
53 drawing processor
54 image masking processor
55 image exposure processor
A1, A2 drawn image
B2 transparent drawing area servable as a masking image
B3 masking drawing-area as a masking image
F finger as an indicating unit
S3 image masking process
S4 image exposure process
S21 indicating situation recognizing process
S22 drawing process

1. An information processing device that processes according to an indicated position defined by indicating a predetermined position on a display surface of a display unit with an indicating unit, the information processing device comprising:
an indicating situation recognizer that recognizes an indicating situation where the indicating unit indicates the display surface;
a drawing processor that superimposes a drawn image according to the indicating situation recognized by the indicating situation recognizer on an image displayed on the display unit;
an image masking processor comprising: a first image masking process mode that hides an area corresponding to the drawn image of the background image when recognizing an image-masking request signal requesting a state where the background image on which the drawn image is superimposed is not displayed; and a second image masking process mode that hides an area other than the area corresponding to the drawn image of the background image when recognizing an image-masking request signal requesting a state where the background image on which the drawn image is not superimposed is not displayed; and
an image exposure processor that displays the hidden background image in an area corresponding to the indicating situation when recognizing the indicating situation by the indicating situation recognizer when the background image is hidden, wherein when a broader area of the background image is to be hidden, the second image masking process mode is capable of specifying an area to be displayed.

2. The information processing device according to claim 1, wherein
the image masking processor and the image exposure processor each switch between a first display image in which the background image on which the drawn image is superimposed is displayed and a second display image in which only the drawn image is displayed while the image is hidden, each time the same operation is repeated by an input unit.

3. The information processing device according to claim 1, wherein
the image masking processor superimposes a masking image having a color different from a color of the drawn image on the background image and superimposes the drawn image on the masking image, thereby displaying only the drawn image while hiding the background image.

4. The information processing device according to claim 3, wherein
the image exposure processor changes the color of the masking image on the area corresponding to the indicating situation to a state of the color where the background image is visible through the masking image, thereby displaying the hidden image.

5. The information processing device according to claim 3, wherein
the drawing processor superimposes on the background image a transparent image through which the background image is visible and on which the drawn image is displayed, and
the image masking processor interposes the masking image between the transparent image and the background image, and superimposes the masking image on the background image to provide a layered structure in which the masking image is visible through the transparent image.

6. A display device comprising:
a display unit having a display surface; and
an information processing device according to claim 1 that processes according to an indicated position defined by indicating a predetermined position on the display surface of the display unit with an indicating unit.

7. The display device according to claim 6, further comprising:
a touch panel that judges the indicating unit to be in contact with the display surface when the indicating unit contacts with the display surface or when the indicating unit comes within a predetermined distance from the display surface, and outputs an area signal according to a contact area, wherein
the indicating situation recognizer recognizes the indicating situation based on a contact state on the touch panel.

8. An information processing method by a computer for processing according to an indicated position defined by indicating a predetermined position on a display surface of a display unit with an indicating unit, the information processing method comprising:
using a touch panel that judges the indicating unit to be in contact with the display surface when the indicating unit contacts with the display surface or when the indicating unit comes within a predetermined distance from the display surface, and outputs an area signal according to a contact area, wherein
the computer is configured to perform:
an indicating situation recognition to recognize an indicating situation where the indicating unit indicates the display surface based on the area signal from the touch panel;
an drawing process to superimpose the same drawn image as an indicating locus recognized by the indicating situation recognition on a background image displayed on the display unit;
an image masking process comprising: a first image masking process mode to recognize an image-masking request signal requesting a state where the background image on which the drawn image is superimposed is not displayed based on the area signal from the touch panel, and to hide an area of the background image corresponding to the drawn image; and a second image masking process mode to recognize an image-masking request signal requesting a state where the background image on which the drawn image is not superimposed is not displayed, and to hide an area other than the area corresponding to the drawn image of the background image; and
an image exposure process to recognize based on the area signal from the touch panel an image display request signal requesting a state where the hidden area is displayed when the area of the image corresponding to the drawn image is hidden, and to display the hidden area, wherein
when a broader area of the background image is to be hidden, the second image masking process mode is capable of specifying an area to be displayed.

9. The information processing method according to claim 8, wherein
each time one drawn image is indicated or one group of drawn images are indicated, the image masking process and the image exposure process are alternately performed on an area corresponding to the indicated one drawn image or one group of drawn images.

10. An information processing method by a computer for processing according to an indicated position defined by indicating a predetermined position on a display surface of a display unit with an indicating unit, wherein
the computer is configured to perform:
an indicating situation recognition to recognize an indicating situation where the indicating unit indicates the display surface;
a drawing process to superimpose a drawn image according to the indicating situation recognized by the indicating situation recognition on a background image displayed on the display unit;
an image masking process comprising: a first image masking process mode to recognize an image-masking request signal requesting a state where the background image on which the drawn image is superimposed by the drawing process is not displayed, and to hide an area corresponding to the drawn image of the background image; and a second image masking process mode to recognize an image-masking request signal requesting a state where the background image on which the drawn image is not superimposed is not displayed, and to hide an area other than the area corresponding to the drawn image of the background image; and
an image exposure process to recognize an indicating situation by the indicating unit when the background image is hidden by the image masking process, and to display the hidden background image in an area corresponding to the indicating situation, wherein
when a broader area of the background image is to be hidden, the second image masking process mode is capable of specifying an area to be displayed.

11. The information processing method according to claim 10, further comprising:
using a touch panel that judges the indicating unit to be in contact with the display surface when the indicating unit contacts with the display surface or when the indicating unit comes within a predetermined distance from the display surface, and outputs an area signal according to a contact area, wherein
the computer recognizes the indicating situation where the indicating unit indicates the display surface based on the area signal from the touch panel in the indicating situation recognition; and
each time the computer recognizes that one drawn image is indicated or one group of drawn images are indicated based on the area signal from the touch panel, the computer alternately perform the image masking process and the image exposure process on an area corresponding to the indicated one drawn image or one group of drawn images.

12. The information processing method according to claim 8, wherein
the area of the background image corresponding to the drawn image is an area filled with the indicating locus or an area enclosed by the indicating locus.

13. The information processing method according to claim 10, wherein
the area of the background image corresponding to the drawn image is an area filled with the indicating locus or an area enclosed by the indicating locus.
